(19) United States
(12) Patent Application Publication
(10) Pub. No.: US 2007/0205074 A1
(43) Pub. Date: Sep. 6, 2007

(54) Clutch release device for a friction clutch of a motor vehicle with a fail-safe system

(75) Inventors: Thomas Otto, Schweinfurt (DE); Herbert Voit, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/713,523

(22) Filed: Mar. 2, 2007

(30) Foreign Application Priority Data
Mar. 3, 2006 (EP) 06 004 316.3

(51) Int. Cl. F16D 21/00

(52) U.S. Cl. 192/98

(57) ABSTRACT

A clutch release device for the friction clutch of a motor vehicle includes a sliding sleeve which can shift position axially on a guide tube, and a roller bearing positioned on the sliding sleeve. The roller bearing includes a first bearing ring, which can rotate with a clutch release element, a second bearing ring, which is fixed against rotation relative to the sliding sleeve, and a plurality of rolling elements which roll on races in the bearing rings. In the event of bearing failure, first and second axial stops engage to prevent relative axial displacement of the bearing rings by more than a predetermined amount. The first axial stop is fixed with respect to the first bearing ring, and the second axial stop is axially fixed with respect to the sliding sleeve.

### BACKGROUND OF THE INVENTION

1. Field of the Invention

The present invention pertains to a clutch-release device including a sliding sleeve which can shift position axially on a guide tube, and a roller bearing positioned on the sliding sleeve, the roller bearing including a first bearing ring, which can rotate with a clutch release element, a second bearing ring, which is fixed against rotation relative to the sliding sleeve, and a plurality of rolling elements which roll on races in the bearing rings.

2. Description of the Related Art

Clutch-release devices of the general type in question for actuating the friction clutches of motor vehicles are sufficiently well known. See, for example, the devices disclosed in U.S. Pat. Nos. 5,295,566 and 5,836,432, both of which are of the “pulled” type. A clutch-release device can also be of the “pushed” type, as described, for example, in DE 101 36 424 C1. These types of clutch-release devices include, as their main component, a clutch-release bearing, designed as a roller bearing, which establishes the working connection between a release element, such as a diaphragm spring, which rotates around the axis of the clutch, and an actuating element, such as a clutch fork, which does not rotate around the axis. The clutch-release bearing, which is usually designed as a radial or angular-contact ball bearing, is subjected not only to high radial forces but also to extreme axial forces, especially when the friction clutch is being actuated. It is possible in practice, such as when there is not enough lubricant available for the clutch-release bearing, for the bearing to run hot. As a result, the ball cage in the roller bearing is destroyed, since it is usually made of plastic, and the rolling elements can no longer be kept the proper distance apart. This can cause the roller bearing to jam and lead to an undesirable axial displacement of the bearing rings with respect to each other. In the worst case, the bearing rings can no longer be held together and, in the case of a clutch of the pulled type, the bearing ring in working connection with the release element can become separated axially from the other bearing ring, as a result of which the friction clutch can no longer be actuated. This problem can also occur in the case of a clutch-release device of the pushed type. In this case, however, because the forces act in the direction opposite those of the pulled device, the bearing rings are not separated from each other but rather pushed axially into each other. Once a certain amount of axial displacement is exceeded, a clutch-release bearing of this type can also fail during operation. In the worst case, a vehicle with a defective clutch-release device of this type can no longer move under its own power and must be towed, even though the drive train and the entire system for transmitting power to the drive wheels are still functional.

### SUMMARY OF THE INVENTION

Against this background, the invention provides a clutch-release device which offers emergency functionality even after the roller bearing has failed, so that the friction clutch of a motor vehicle can be actuated at least for a limited period of time or for a limited driving distance.

According to the invention, the clutch-release device includes first and second axial stops, which form an engagement formation to prevent the bearing rings from becoming displaced essentially in the axial direction by more than a pre-determined amount. The bearing ring in working connection with the clutch-release element has the first axial stop, whereas the second axial stop is held in an axially permanent position with respect to the sliding sleeve.

The axial stops themselves can be designed in numerous ways. For example, the two bearing rings can have flanges or ring-shaped webs which at least partially overlap each other radially, and which, when a defect develops, prevent unallowed axial displacement of the bearing ring in working connection with the clutch-release element of the friction clutch by coming to rest axially against the other bearing ring. The flanges or ring-shaped webs required for this can be designed as integral parts of the bearing rings, or they can be installed as additional parts on the bearing rings and secured axially in place, where known and suitable positive, nonpositive, or seamless bonding techniques can be used. The second axial stop could also be designed, for example, as a tubular element permanently mounted axially on the sliding sleeve, this tubular element being provided with a ring-shaped collar, and this collar being located so that it at least partially overlaps radially the first axial stop. The second axial stop could also be a retaining clamp attached to the sliding sleeve to hold the clutch-release bearing in position or a retaining plate with a radial section for the same purpose, such plates usually being provided with such radial sections in any case.

When damage occurs to the bearing of a clutch-release device of this type, especially when a defect develops in the ball cage or when the cage is destroyed, the axial forces which are exerted on the clutch-release device when the friction clutch is actuated can displace the two bearing rings axially with respect to each other only up to a certain predetermined extent, namely, up to the point that the engagement formation formed by the axial stops blocks any further axial displacement. The extent of the maximum possible axial displacement is selected advantageously so that, when this situation occurs, the rolling elements, although no longer in optimal contact with their raceways, nevertheless still rest at least partially on them and the functionality of the clutch-release bearing is essentially guaranteed. Thus a vehicle with a clutch-release device which has been damaged in the manner explained above will still be able to move independently at least for a limited time and/or over a limited distance, that is, without being towed, and can thus be driven to, for example, a repair garage.

The basic idea of the invention explained above can be realized in practice in many different ways.

According to an advantageous embodiment, the first and the second axial stops are not in working connection with each other or are connected to each other in an essentially force-free manner during normal operation, i.e., during operation of the clutch-release device with a properly working clutch-release bearing. For normal operation, it is best for the axial stops to have no effect on the components in question. For this purpose, it can be advantageous to provide an air gap between the axial stops, so that the axial stops are unable to exert any effects on each other. Alternatively, however, the axial stops intended to engage with each other can have a bearing between them, such as an axial ball bearing, which rotates under essentially no-load conditions during normal operation.

To guarantee that the clutch-release device can continue to operate even under emergency conditions, it is advantageous for the first and second axial stops to arrive in a state of engagement with each other under the effect of axial load as soon as a defect which leads to a mutual axial displacement of the bearing rings of the clutch-release bearing occurs in the clutch-release bearing.

When the axial stops are a certain distance away from each other during normal operation and come to rest against each other when the bearing becomes defective, it is highly favorable for the first and the second axial stops to have surfaces which are optimized for sliding behavior and which form a friction bearing when a defect occurs. For this purpose, at least one of the sliding contact surfaces can be enhanced by a coating of plastic, for example, or by a metal coating known to the man of the art such as a coating of lead, tin, aluminum, or copper alloy. As a result of this measure, frictional losses can be reduced, and the emergency running properties of the clutch-release device are improved.

The activation of the engagement formation explained above takes place unnoticeably to the vehicle's driver when a defect occurs; that is, the driver cannot tell that a defect has developed in the clutch-release device. According to an especially preferred elaboration of the invention, therefore, a sensor arrangement is therefore provided to detect changes in the axial positions of the bearing rings with respect to each other, that is, to detect deviations from the normal state, or to detect that the two parts of the engagement formation have become engaged with each other under the effect of axial force. The sensor arrangement will therefore detect such situations and send the driver a signal to that effect in the form of a visual or acoustic signal or in some other suitable way.

The proposed clutch-release device can be either of the “pulled” type or of the “pushed” type.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows an axial cross section through the clutch-release device of a pulled friction clutch according to the prior art;

FIG. 2 shows a clutch-release device according to FIG. 1 comprising axial stop which are formed as integral parts of the bearing rings to form a fail-safe system;

FIG. 3 shows a clutch-release device according to FIG. 1, in which separate elements are used to form the fail-safe system; and

FIG. 4 shows a clutch-release device according to FIG. 1, where, to form a fail-safe system, a section of the inner ring of the bearing cooperates with a retaining clamp.

### DETAILED DESCRIPTION OF THE PRESENTLY PREFERRED EMBODIMENTS

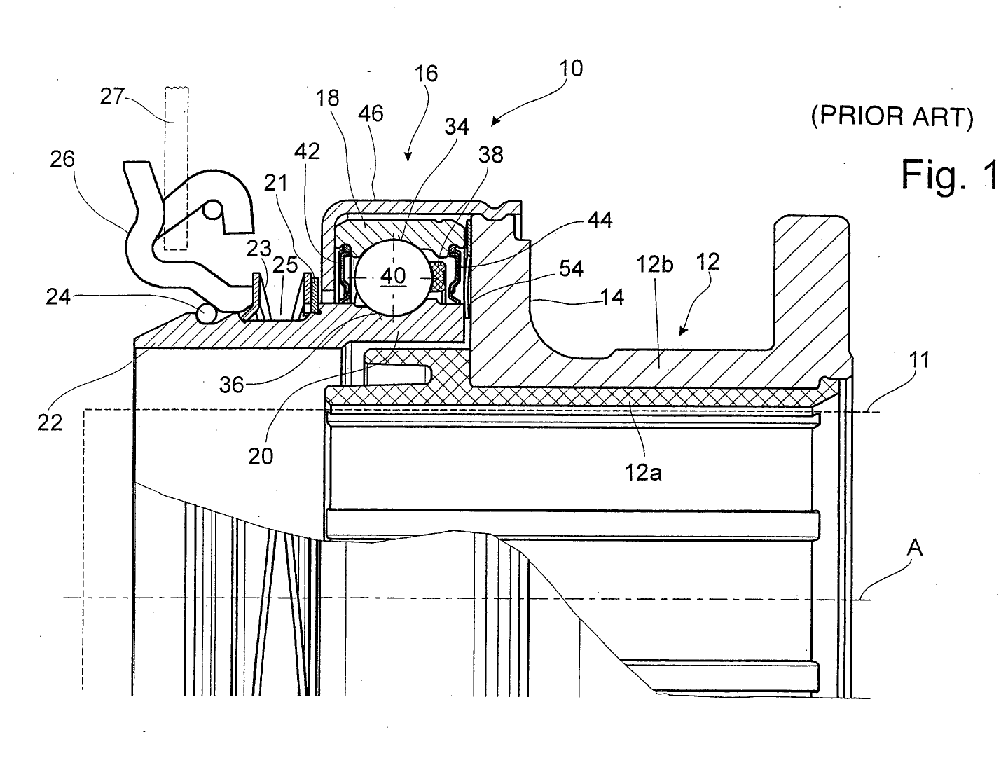

FIG. 1 shows a clutch-release device 10 of the pulled type for actuating a motor vehicle friction clutch (not shown in the drawing). The device includes a sliding sleeve 12, which is made up of two parts, namely, an inner part 12a and an outer part 12b. The sleeve is able to shift its position axially on a guide tube. The sleeve has a radial flange 14, to which is attached a clutch-release bearing 16, designed as an angular-contact ball bearing. The ball bearing 16 has a first, radially outer bearing ring 18, which is stationary with respect to the sliding sleeve 12, and a rotating second, radially inner bearing ring 20 with an axial extension 22 which extends beyond the bearing 16. The inner ring is in working connection by means of a load ring 24 and a release ring 26 with the ends of the tongues of a diaphragm spring 27 (only partially shown in the figure), which represents the release element of the friction clutch to be actuated. To guarantee that the release ring 26 rests without play against the load ring 24, a wave washer 23 is provided, which is inserted into a groove 25 formed in the inner bearing ring 20 and is supported axially by way of a lock washer 21 against the inner bearing ring 20.

The bearing rings 18, 20 have races 34, 36, which face each other, to hold a plurality of balls 40, which are guided in, and kept a certain distance apart from each other by, a ball cage 38. To prevent the intrusion of dirt and also to prevent the lubricant present in the interior of the bearing from escaping, two contact seals 42, 44 are provided at the ends between the bearing rings 18, 20.

The radial flange 14 carries a retaining plate 46, the edge of which is roll-bonded onto the flange. The plate grips the radially outer, stationary bearing ring 18 and the seals 42, 44 and thus holds the roller bearing 16 in place axially on the sliding sleeve 12.

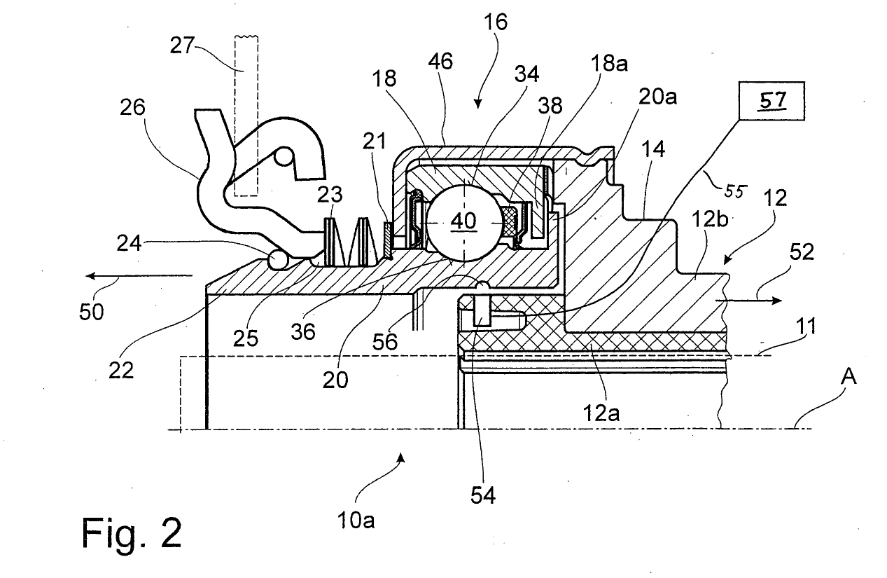

FIG. 2 shows a clutch-release device 10a, the design of which is basically the same as that of the clutch-release device 10 explained above. It can be seen, however, that the bearing rings 18, 20 are modified on the axial side of the clutch-release bearing 16 facing the sliding sleeve 12. The outer bearing ring 18 mounted nonrotatably on the radial flange 14 is provided with a radially inward-oriented, ring-shaped web 18a, and the inner bearing ring 20 in working connection with the clutch-release element is provided with a radially outward-oriented, ring-shaped web 20a. The two webs are a certain axial distance apart, but they radially overlap each other at least partially. The two ring-shaped webs 20a, 18a act as the first and second axial stops 20a, 18a, which form together an engagement formation 48, that is, the fail-safe system of the clutch-release device 10a.

In general, the rotating bearing ring 20 in working connection with the clutch-release element 27 has the first axial stop 20a, whereas the second axial stop 18a is held in a fixed position with respect to the sliding sleeve 12. The axial stops 18a, 20a in this exemplary embodiment, namely, the ring-shaped webs 18a, 20a, are axially offset from each other in such a way that the second axial stop 18a, viewed from the position of the first axial stop 20a, is located axially downstream from the first axial stop 20a with respect to the direction of the force, indicated in FIG. 2 by the arrow 50, which acts on the bearing ring 20 connected to the clutch-release element 27 when the pulled friction clutch is released.

The first and the second axial stops 20a, 18a are therefore not in working connection with each other during normal operation. The fail-safe function generated by the engagement formation 20a, 18a is not activated until, as the result of a defect in the clutch-release bearing, such as in the case of a worn-out ball cage 38, the action of the force exerted by the release element 27 during a release process in the direction of the arrow 52 causes the bearing rings 18, 20 to shift axially with respect to each other. The bearing ring 20 in working connection with the release element is prevented from being displaced by more than a certain amount in that the first axial stop 20a formed on it makes contact with the second axial stop 18a formed on the other bearing ring 18. The two axial stops thus arrive in engagement with each other under the action of axial force, as a result of which the clutch-release device 10a can continue to operate even under these emergency conditions. The surfaces of the ring-shaped webs 18a, 20a which come in contact with each other are optimized for sliding contact to reduce friction. This can be accomplished, for example, by providing a plastic coating on at least one of the axial stops 18a, 20a and/or by optimizing the contact geometry, e.g., by forming a convex contact surface to realize linear contact. The mutual contact area can also be designed in segments, adjacent to each other in the circumferential direction, as a result of which the contact area is further reduced.

So that it is possible to detect the presence of emergency running conditions, that is, to detect the forcible engagement of the engagement formation 18a, 20a, the clutch-release device 10a comprises a sensor arrangement, consisting of an inductive sensor 54 mounted on the sliding sleeve and a marker 56, which differs with respect to its magnetic properties from the material of the inner bearing ring 20. This marker can be, for example, in the form of a recess or a piece of inlaid material extending radially around the inner bearing ring, radially opposite the sensor 54. A change in the axial positions of the bearing rings 18, 20 with respect to each other, i.e., a change which indicates a defect in the clutch-release bearing 10a, can be easily detected in this way by the sensor 54, and a perceptible signal can be transmitted over a signal line 55 and via evaluation circuit 57 to the driver of the vehicle.

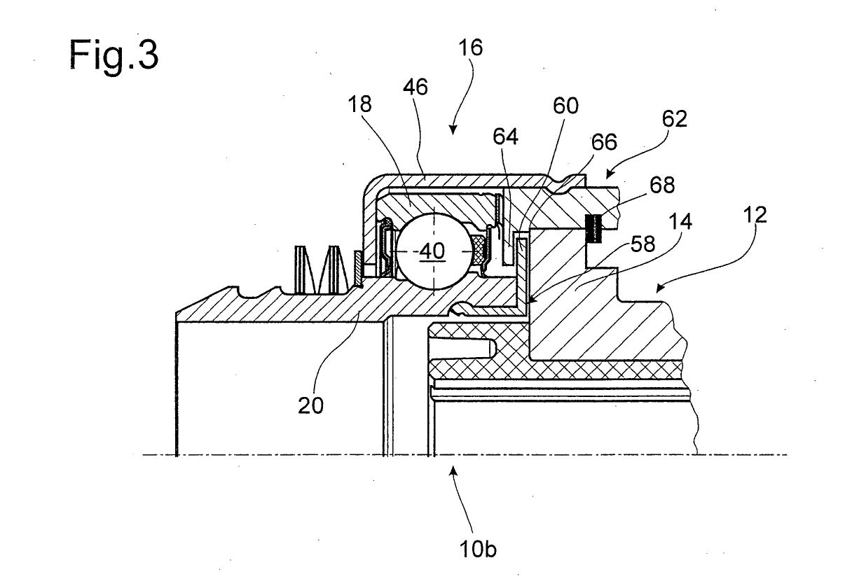

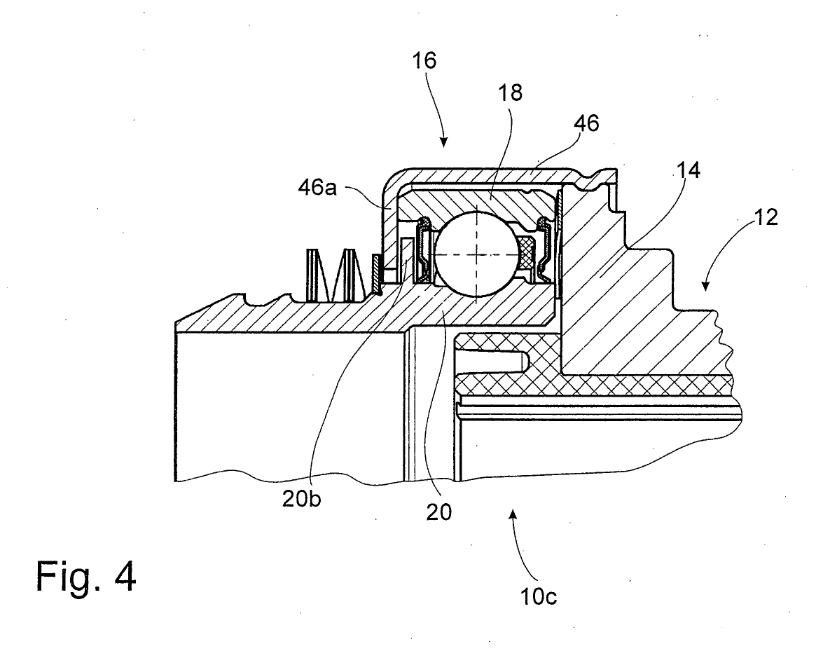

The exemplary embodiments shown in FIGS. 3 and 4 show two additional clutch-release devices 10b, 10c, where here, too, the bearing ring 20 provided to cooperate with the clutch-release element has the first axial stop, whereas the second axial stop is held in an axially permanent position with respect to the sliding sleeve 12. The way in which the fail-safe device works as explained above on the basis of FIG. 2 applies equally to the exemplary embodiments explained below.

The special feature of the design in FIG. 3 is to be seen in that the first axial stop is formed by a sleeve element 58, the edge of which is roll-welded onto the inner circumferential surface of the inner bearing ring 20. The ring-shaped disk section 60 of the sleeve element is a certain axial distance away from, and at least partially radially overlaps, the radial collar 64 of a tubular element 62, which is mounted on the sliding sleeve 12 and which represents the second axial stop. The tubular element 62 is held in place axially on the sliding sleeve 12 on one side by a diametral shoulder 66 and on the other side by a lock washer 68, which grips an axial contact surface of the sliding sleeve 12. The retaining plate 46 which holds the clutch-release bearing 16 is roll-welded onto the tubular element 62.

In the exemplary embodiments according to FIGS. 2 and 3, the fail-safe device is on the side of the clutch-release bearing 16 facing the radial flange 14. According to FIG. 4, there is also the possibility of providing the fail-safe device on.,the side of the clutch-release bearing facing away from the radial flange 14. For this purpose, a radially outward-projecting, ring-shaped web 20b is provided on the inner bearing ring 20 as the first axial stop, this web being a certain axial distance away from, and at least partially radially overlapping, a radial section 46a of the retaining plate 46, which represents the second axial stop. Because the retaining plate 46 is provided in any case on the clutch-release device 10c, it is possible in this case to omit special measures for forming the second axial stop.

A sensor arrangement according to FIG. 2 for detecting emergency running conditions can also be integrated into the clutch-release devices 10b and 10c according to FIGS. 3 and 4.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A clutch release device for the friction clutch of a motor vehicle, said release device comprising:
a sliding sleeve which can shift position axially on a guide tube;
a roller bearing positioned on the sliding sleeve, the roller bearing comprising a first bearing ring, which can rotate with a clutch release element, a second bearing ring, which is fixed against rotation relative to the sliding sleeve, and a plurality of rolling elements between the bearing rings; and
first and second axial stops which can engage to prevent relative axial displacement of the bearing rings by more than a predetermined amount, the first axial stop is fixed with respect to the first bearing ring, and the second axial stop is axially fixed with respect to the sliding sleeve.

2. The clutch release device of claim 1 wherein, during normal operation, there is no axial force between the axial stops.

3. The clutch release device of claim 1 wherein, in the event of bearing failure, the axial stops can engage with axial force to permit releasing the clutch.

4. The clutch release device of claim 1 wherein the bearing rings have respective mutually facing contact surfaces which slide over each other when the stops are engaged.

5. The clutch release device of claim 1 further comprising a sensor arrangement which can detect a relative axial displacement of the bearing rings.
